(19) United States
(12) Patent Application Publication
(10) Pub. No.: US 2017/0146415 A1
(43) Pub. Date: May 25, 2017

(54) Cylinder Internal Pressure Sensor

(71) Applicant: TOYOTA JIDOSHA KABUSHIKI KAISHA, Toyota-shi (JP)

(72) Inventor: Seiji HASHIMOTO, Toyota-shi (JP)

(73) Assignee: TOYOTA JIDOSHA KABUSHIKI KAISHA, Toyota-shi (JP)

(21) Appl. No.: 15/346,365

(22) Filed: Nov. 8, 2016

(30) Foreign Application Priority Data
Nov. 24, 2015 (JP) 2015-228941

(51) Int. Cl. G01L 9/00; G01M 15/08

(52) U.S. Cl. CPC G01L 9/0051; G01M 15/08

(57) ABSTRACT

A cylinder internal pressure sensor configured to be subjected to heat of combustion inside a combustion chamber and a pressure inside the combustion chamber, and including: a housing; a diaphragm joined to one end of the housing and being configured to deflect according to the pressure inside the combustion chamber; a sensor element housed inside the housing, being coupled to the diaphragm; and being configured to change a signal to be output according to a temperature inside the combustion chamber and the pressure inside the combustion chamber; a heating element configured to heat the sensor element; and a control unit configured to control the amount of heat generated by the heating element such that the temperature of the sensor element becomes higher than a first predetermined temperature that is the temperature of the sensor element when subjected to the heat of combustion is provided.

### INCORPORATION BY REFERENCE

The disclosure of Japanese Patent Application No. 2015-228941 filed on Nov. 24, 2015 including the specification, drawings and abstract is incorporated herein by reference in its entirety.

### BACKGROUND

1. Technical Field

The present disclosure relates to a cylinder internal pressure sensor for detecting a cylinder internal pressure that is the pressure inside the combustion chamber of an internal combustion engine.

2. Description of Related Art

The cylinder internal pressure sensor described in Japanese Patent Application Publication No. 2004-108896 has a sensor element that changes in resistance value according to pressure and temperature. The sensor element is supplied with a constant current, and when the resistance value of the sensor element changes, a voltage occurring across both ends of the sensor element (end-to-end voltage) changes. A signal corresponding to the end-to-end voltage is input into a circuit part of the cylinder internal pressure sensor. The circuit part derives a difference between the end-to-end voltage of the sensor element that reflects the influence of pressure and temperature and a bottom voltage that reflects only the influence of temperature, and thereby eliminates the influence of the temperature inside the combustion chamber and detects a signal reflecting the state of the cylinder internal pressure. The cylinder internal pressure sensor described in JP 2004-108896 A detects the cylinder internal pressure in such a circuit configuration.

In the cylinder internal pressure sensor described in JP 2004-108896 A, the bottom voltage is set as follows. As indicated by the solid line in FIG. 7, an end-to-end voltage V1 of the sensor element changes periodically according to the cylinder internal pressure. The minimum voltage at time Ti (i=1, 2, 3 . . . ) at which the decreasing end-to-end voltage V1 starts to increase, i.e., the voltage detected when combustion is not occurring in the combustion chamber, reflects only the influence of the temperature. As indicated by the one-dot dashed line in FIG. 7, a bottom voltage V2 used in the circuit part is set with a predetermined gradient so as to increase gradually as time elapses. The bottom voltage V2 is set so as to remain at the same level as the end-to-end voltage V1 of the sensor element after reaching the same level as the end-to-end voltage V1, and to increase gradually from time Ti until reaching the same level as the end-to-end voltage V1 again. In such a configuration, the value of the bottom voltage V2 becomes equal to the value of the minimum voltage of the end-to-end voltage V1 at time Ti. Accordingly, as indicated by the two-dot dashed line in FIG. 7, it is possible to eliminate the influence of the temperature inside the combustion chamber and detect a signal reflecting the state of the cylinder internal pressure by deriving the difference between the end-to-end voltage V1 of the sensor element and the bottom voltage V2.

### SUMMARY

For example, when the heat of combustion fluctuates significantly, the sensor element may undergo a significant temperature change by being subjected to the heat of combustion. Meanwhile, the minimum voltage of the end-to-end voltage V1 of the sensor element may change to a larger degree as shown in FIG. 8. In such cases, the bottom voltage V2, which is set with a constant gradient, cannot follow the changes in the minimum voltage, and therefore the bottom voltage V2 cannot be set to the minimum voltage. Accordingly, the influence of the temperature cannot be sufficiently removed even when the difference between the end-to-end voltage V1 of the sensor element and the bottom voltage V2 is derived.

The present disclosure provides a cylinder internal pressure sensor that can more properly remove the influence of temperature on the end-to-end voltage of the sensor element regardless of the degree of changes in heat of combustion.

According to an aspect of the disclosure, a cylinder internal pressure sensor is provided. The cylinder internal pressure sensor is disposed inside a combustion chamber of an internal combustion engine, and configured to be subjected to heat of combustion inside the combustion chamber and a pressure inside the combustion chamber. The cylinder internal pressure sensor includes: a housing; a diaphragm joined to one end of the housing and configured to deflect according to the pressure inside the combustion chamber; a sensor element housed inside the housing, being coupled to the diaphragm, and being configured to change a signal to be output according to a temperature inside the combustion chamber and the pressure inside the combustion chamber; a heating element configured to heat the sensor element; and a control unit configured to control the amount of heat generated by the heating element such that the temperature of the sensor element becomes higher than a first predetermined temperature that is the temperature of the sensor element when subjected to the heat of combustion.

According to the above configuration, the temperature of the sensor element is higher than the temperature based on the assumption that the sensor element is subjected to the heat of combustion, so that the sensor element undergoes little temperature change even when subjected to the beat of combustion. Thus, it is possible to make it less likely that the influence of a temperature change due to the heat of combustion is reflected in the end-to-end voltage of the sensor element, and to make it more likely that the end-to-end voltage of the sensor element reflects only the influence of the cylinder internal pressure. According to the above configuration, therefore, the influence of temperature on the end-to-end voltage of the sensor element can be removed more properly regardless of the degree of changes in heat of combustion.

According to the above configuration, the control unit may be configured to control the amount of heat generated by the heating element such that the temperature of the sensor element becomes higher than a second predetermined temperature that is a highest temperature reached by the sensor element when subjected to the heat of combustion.

According to the above configuration, the temperature of the sensor element is maintained at the predetermined temperature that is higher than the highest temperature reached by the sensor element when subjected to the heat of combustion. Thus, complication of controlling the heating element is avoided, and therefore the behavior of the heating element is stabilized.

According to the above configuration, the cylinder internal pressure sensor may further include a thermal insulation member housed inside the housing, wherein the heating element is fixed at one end face to the sensor element and at the other end face to the thermal insulation member.

According to the above configuration, the thermal insulation member can prevent the heat of the heating element from escaping through the other end face, so that the heat can be transferred intensively from the heating element to the sensor element. Thus, the heating element can heat the sensor element with higher efficiency.

According to the above configuration, the cylinder internal pressure sensor may further include an adhesive layer provided between the heating element and the sensor element. The adhesive layer contains carbon and an adhesive, wherein the heating element and the sensor element are fixed to each other through the adhesive layer.

According to the above configuration, the thermal conductivity of the adhesive layer can be increased, so that a larger amount of heat can be transferred from the heating element to the sensor element through the adhesive layer.

### BRIEF DESCRIPTION OF THE DRAWINGS

Features, advantages, and technical and industrial significance of exemplary embodiments will be described below with reference to the accompanying drawings, in which like numerals denote like elements, and wherein:

FIG. 1 is a sectional view schematically showing the configuration of an internal combustion engine including a cylinder internal pressure sensor;

FIG. 2 is an enlarged sectional view showing a leading end part of the cylinder internal pressure sensor;

FIG. 3 is a perspective view showing the configuration of a sensor element and a ceramic heater;

FIG. 4 is a graph showing changes in an end-to-end voltage detected in a circuit part of a cylinder internal pressure sensor of the related art;

FIG. 5 is a graph showing changes in an end-to-end voltage detected in a circuit part of one embodiment of the cylinder internal pressure sensor;

FIG. 6 is a graph showing the end-to-end voltage after being amplified in the circuit part;

FIG. 7 is a graph showing changes in an end-to-end voltage of a sensor element and in a bottom voltage and an output voltage in a circuit part in one example of a cylinder internal pressure sensor of the related art; and

FIG. 8 is a graph showing changes in the end-to-end voltage and the bottom voltage in the circuit part when the sensor element undergoes significant temperature changes in the example of the cylinder internal pressure sensor of the related art.

### DETAILED DESCRIPTION OF EMBODIMENTS

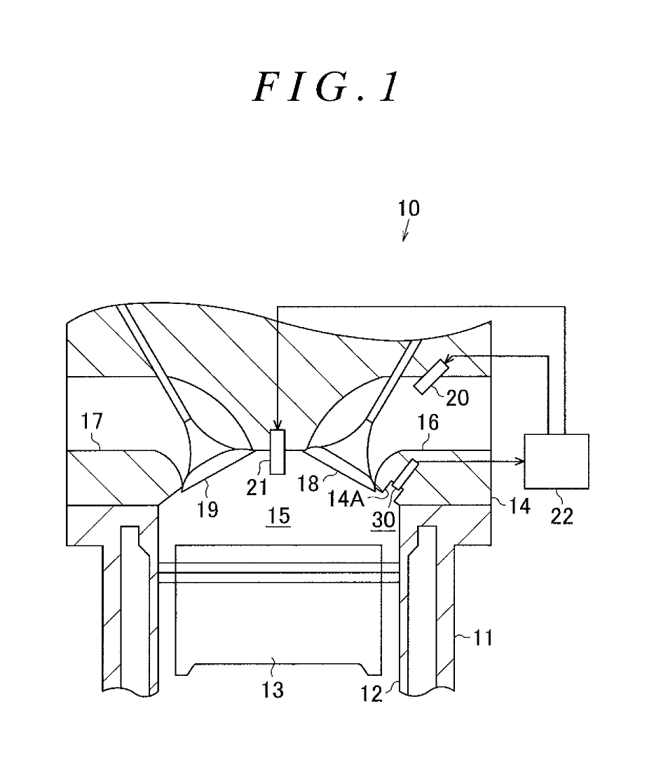

One embodiment of a cylinder internal pressure sensor will be described with reference to FIG. 1 to FIG. 6. As shown in FIG. 1, an internal combustion engine 10 including the cylinder internal pressure sensor has a cylinder block 11. A cylinder 12 is formed inside the cylinder block 11. A piston 13 is provided inside the cylinder 12 so as to be reciprocal. A cylinder head 14 is fixed to an upper part of the cylinder block 11. A combustion chamber 15 is defined by the lower surface of the cylinder head 14, the inner surface of the cylinder 12, and the upper surface of the piston 13. The cylinder head 14 is provided with an intake port 16 and an exhaust port 17 each connected to the combustion chamber 15. The intake port 16 is provided with an intake valve 18 that provides and cuts off communication between the intake port 16 and the combustion chamber 15, and the exhaust port 17 is provided with an exhaust valve 19 that provides and cuts off communication between the exhaust port 17 and the combustion chamber 15. The intake port 16 is provided with a fuel injection valve 20 that injects fuel into the intake port 16. The fuel injected into the intake port 16 is mixed with intake air and introduced into the combustion chamber 15. The cylinder head 14 is provided with a spark plug 21 that initiates the combustion of the mixture of the fuel and the intake air introduced into the combustion chamber 15. The mixture combusted inside the combustion chamber 15 is discharged as exhaust gas through the exhaust port 17.

The cylinder head 14 is provided with a cylinder internal pressure sensor 30. A recess 14A is formed in the lower surface of the cylinder head 14, and the cylinder internal pressure sensor 30 has one end exposed to a space surrounded by the recess 14A. This space constitutes a part of the combustion chamber 15. By detecting a pressure acting on the one end, the cylinder internal pressure sensor 30 detects a cylinder internal pressure that is the pressure inside the combustion chamber 15. Signals output from various sensors, including the cylinder internal pressure sensor 30, are input into a control device 22 of the internal combustion engine 10. On the basis of these signals, the control device 22 controls the fuel injection amount of the fuel injection valve 20 and the ignition timing of the spark plug 21.

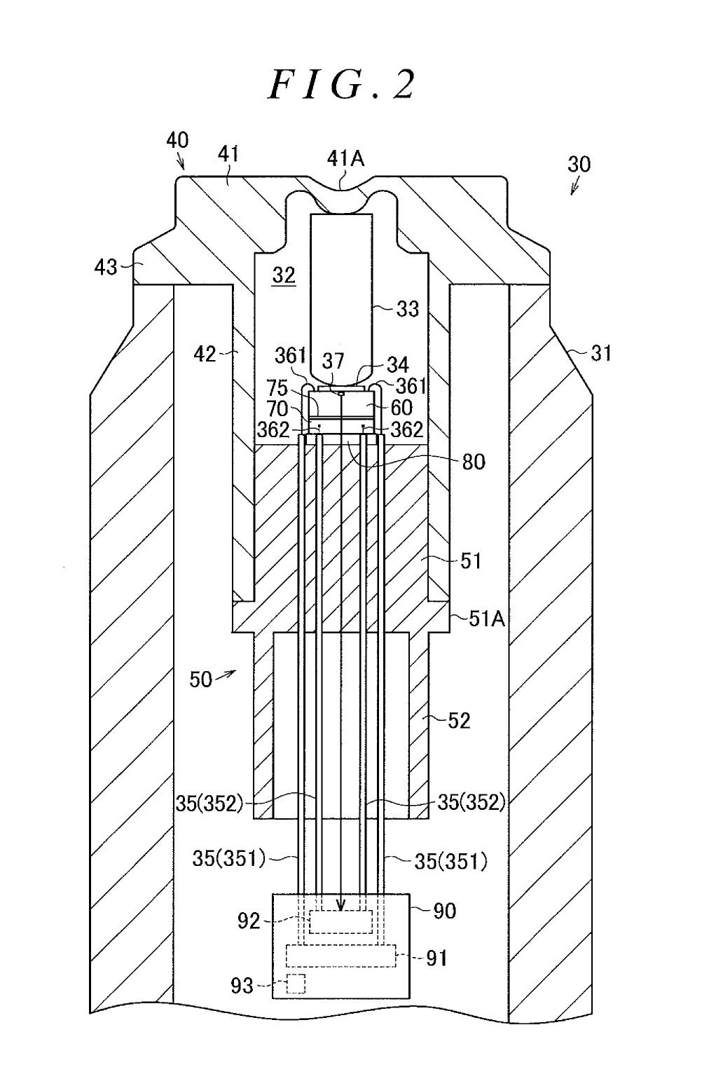

As shown in FIG. 2, the cylinder internal pressure sensor 30 has a cylindrical housing 31. A flexible diaphragm 40 is provided at one end of the housing 31. The diaphragm 40 is made of metal, for example, and covers the end of the housing 31. The diaphragm 40 has a main body part 41 and an extension part 42 cylindrically extended from the main body part 41 into the housing 31. The extension part 42 is separated from the inner surface of the housing 31. On the outer circumferential surface of the main body part 41, a flange 43 is provided of which the diameter is enlarged outward and the outer circumferential surface is substantially flush with the outer circumferential surface of the housing 31. The flange 43 is joined by welding etc. to the one end of the housing 31. The diaphragm 40 is thereby fixed to the housing 31. A center portion of the main body part 41 is smaller in plate thickness than a peripheral portion thereof, and constitutes a flexible portion 41A that deflects according to the cylinder internal pressure. The flexible portion 41A is curved toward the inside of the housing 31 (downward in FIG. 2) in the direction of an axis of the housing 31 (upper-lower direction in FIG. 2).

An opposed member 50 is disposed in an internal region of the housing 31 so as to face the diaphragm 40. The opposed member 50 has a columnar insert part 51. The insert part 51 is inserted into the extension part 42, with the outer surface of the insert part 51 in contact with the inner surface of the extension part 42. The insert part 51 has an engaging portion 51A formed therein that protrudes outward from the outer circumferential surface of the insert part 51, and the engaging portion 51A is fixed to the end face of the extension part 42 of the diaphragm 40. The opposed member 50 has a cylindrical annular part 52 provided upright on the end face of the insert part 51 opposite from the end face on the side of the diaphragm 40. The annular part 52 extends in a direction away from the diaphragm 40. The outer diameter of the annular part 52 is substantially equal to the outer diameter of the insert part 51. The opposed member 50 is made of metal, for example, and the insert part 51 and the annular part 52 thereof are formed as an integral part. A housing room 32 is defined by the end face of the insert part 51 of the opposed member 50 facing the diaphragm 40 and the inner surface of the diaphragm 40.

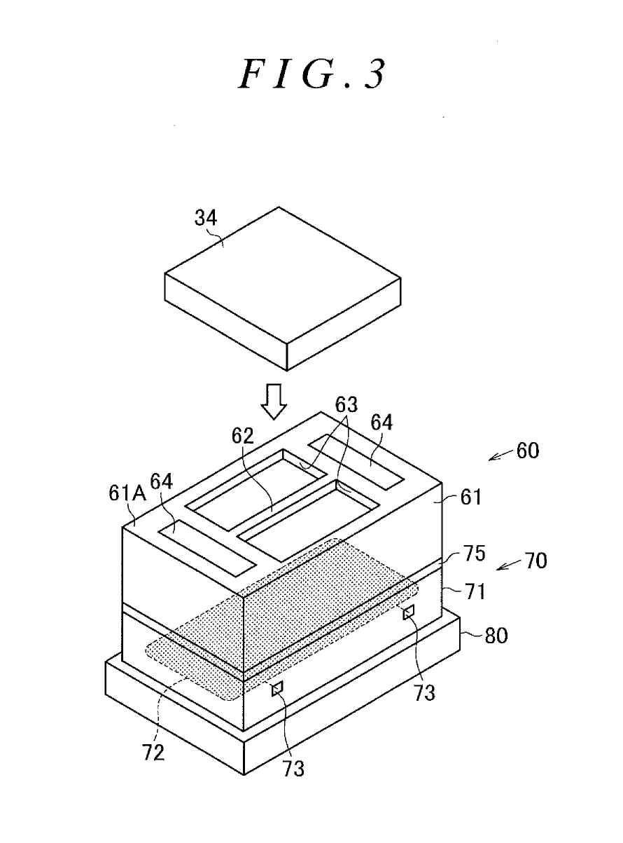

A force transmission rod 33 is housed inside the housing room 32. The force transmission rod 33 has one end (upper end in FIG. 2) coupled to the inner surface of the flexible portion 41A of the diaphragm 40. A sensor element 60 is coupled through a glass block 34 to the other end (lower end in FIG. 2) of the force transmission rod 33. As shown in FIG. 2 and FIG. 3, the sensor element 60 is made of silicon, for example, and has a substantially rectangular parallelepiped base part 61. An upper end face 61A of the base part 61 has a mesa portion 62 formed therein that is a mesa-shaped protrusion and changes in resistance value according to pressure and temperature. The mesa portion 62 is formed by forming two grooves 63 in the upper end face 61A. The glass block 34 is fixed by anodic bonding, for example, to the upper end face 61A of the sensor element 60 so as to cover the mesa portion 62 and the grooves 63. The base part 61 is provided with a pair of electrodes 64 on both sides across the mesa portion 62. One end of the mesa portion 62 is electrically connected to one of the electrodes 64, while the other end of the mesa portion 62 is electrically connected to the other electrode 64.

A ceramic heater 70 as a heating element is fixed to the sensor element 60. The ceramic heater 70 has a rectangular parallelepiped holder 71. The holder 71 is made of ceramic having insulation properties, and the upper end face of the holder 71 has substantially the same shape as the lower end face of the base part 61 of the sensor element 60. Inside the holder 71, a heat generator 72 made of a metal sheet or a metal wire, for example, is provided. A pair of electrodes 73 arranged on a side surface of the holder 71 is connected to the heat generator 72. When a current is applied to the heat generator 72 through the pair of electrodes 73, the heat generator 72 generates heat, which warms the sensor element 60. An adhesive layer 75 is provided between the sensor element 60 and the ceramic heater 70. The adhesive layer 75 is made of an adhesive containing carbon. In this embodiment, this adhesive is applied to the entire upper end face of the holder 71 of the ceramic heater 70, and in this state, the lower end face of the base part 61 of the sensor element 60 is bonded to the upper end face of the holder 71 to fix the ceramic heater 70 and the sensor element 60 to each other through the adhesive layer 75.

A thermal insulation member 80 is fixed to the lower end face of the holder 71. Accordingly, the ceramic heater 70 is fixed at one end face to the sensor element 60 and at the other end face to the thermal insulation member 80. The thermal insulation member 80 is made of zirconia, and the thermal conductivity of the thermal insulation member 80 is lower than that of the ceramic heater 70 or the adhesive layer 75. As shown in FIG. 2, the thermal insulation member 80 is fixed to the insert part 51 of the opposed member 50 and housed inside the housing room 32.

As shown in FIG. 2, the cylinder internal pressure sensor 30 is provided with a circuit part 90. The circuit part 90 is provided with a constant current unit 91, a control unit 92, and a detection unit 93. Two pairs of thin long terminals 35 that extend in the direction of the axis of the housing 31 so as to penetrate the insert part 51 of the opposed member 50 are coupled to the circuit part 90. One pair of the two pairs of terminals 35 is connected to the constant current unit 91, while the other pair is connected to the control unit 92. One pair of terminals 351 connected to the constant current unit 91 are coupled to the pair of electrodes 64 of the sensor element 60 through lead wires 361. The constant current unit 91 has a constant current source and is controlled such that a constant current flows the constant current unit 91. Accordingly, the sensor element 60 is supplied with a constant current through the terminals 351. In the state of the cylinder internal pressure sensor 30 being installed in the internal combustion engine 10, the cylinder internal pressure acts on the diaphragm 40. When the flexible portion 41A of the diaphragm 40 deflects toward the housing 31 (downward in FIG. 2) according to the cylinder internal pressure, the glass block 34 is pressed toward the sensor element 60 through the force transmission rod 33. When a load acts on the sensor element 60, the resistance value of the mesa portion 62 changes, so that a voltage occurring across the pair of electrodes 64 changes. A signal corresponding to this voltage is output to the detection unit 93 of the circuit part 90.

One pair of terminals 352 connected to the control unit 92 are coupled to the pair of electrodes 73 of the ceramic heater 70 through lead wires 362. By controlling the current supplied to the ceramic heater 70, the control unit 92 controls the amount of heat generated by the ceramic heater 70. The cylinder internal pressure sensor 30 is provided with a temperature sensor 37 that detects the temperature of the sensor element 60, and an output signal of the temperature sensor 37 is input into the control unit 92. On the basis of the signal from the temperature sensor 37, the control unit 92 perfoims feedback control of the current supplied to the ceramic heater 70.

The feedback control performed by the control unit 92 will be described below. The control unit 92 has stored therein a highest temperature reached by the sensor element 60 when subjected to the heat of combustion during steady operation of the internal combustion engine, i.e., during engine operation in which abnormal combustion, such as knocking or pre-ignition, is not occurring. This temperature is one example of the second predetermined temperature. The second predetermined temperature is the highest temperature of the temperatures of the sensor element 60 when the heat from the ceramic heater 70 is not input into the sensor element 60 and the sensor element 60 is subjected to only the heat of combustion, and this temperature can be obtained in advance by simulation, experiment, etc. The control unit 92 sets as a predetermined temperature a temperature that is 10° C. higher than the above temperature of the sensor element 60 stored in advance, and controls the amount of current applied to the ceramic heater 70 on the basis of the temperature of the sensor element 60 detected by the temperature sensor 37. For example, when the temperature of the sensor element 60 is low, such as at the start of the internal combustion engine 10, there is a large discrepancy between the predetermined temperature and the actual temperature of the sensor element 60. Therefore, the control unit 92 increases the amount of current applied to the ceramic heater 70 to quickly raise the temperature of the sensor element 60. Then, after the temperature of the sensor element 60 has risen to the predetermined temperature, the control unit 92 intermittently applies a current to the ceramic heater 70 so as to control the temperature of the sensor element 60 to the predetermined temperature. Under such control, the temperature of the sensor element 60 is controlled to be higher than the highest temperature reached by the sensor element 60 when subjected to the heat of combustion during steady operation of the internal combustion engine.

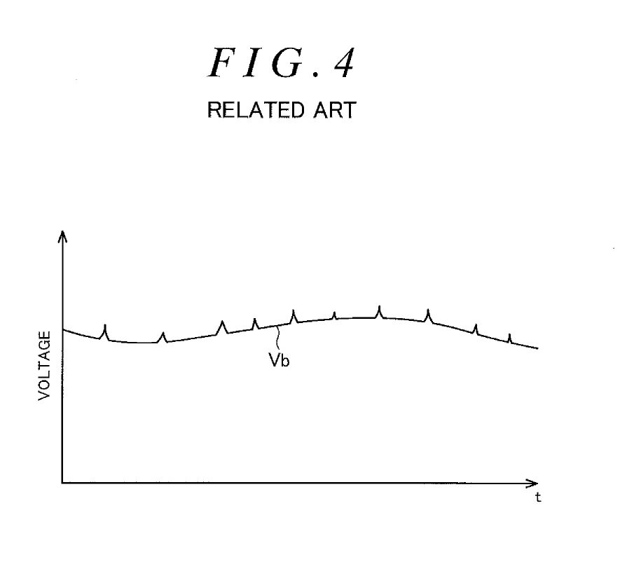

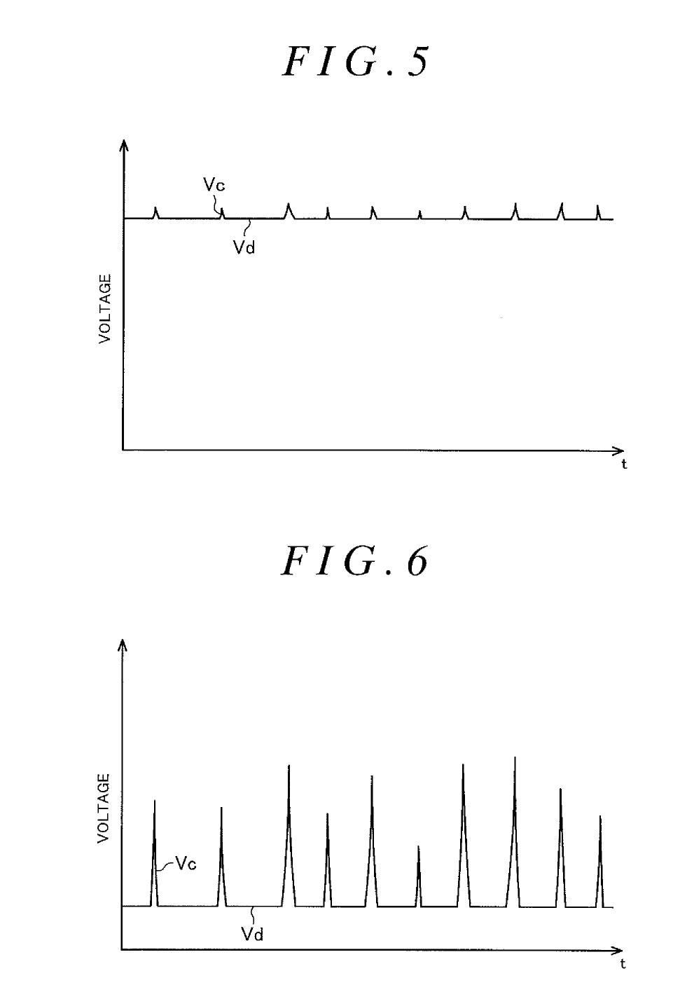

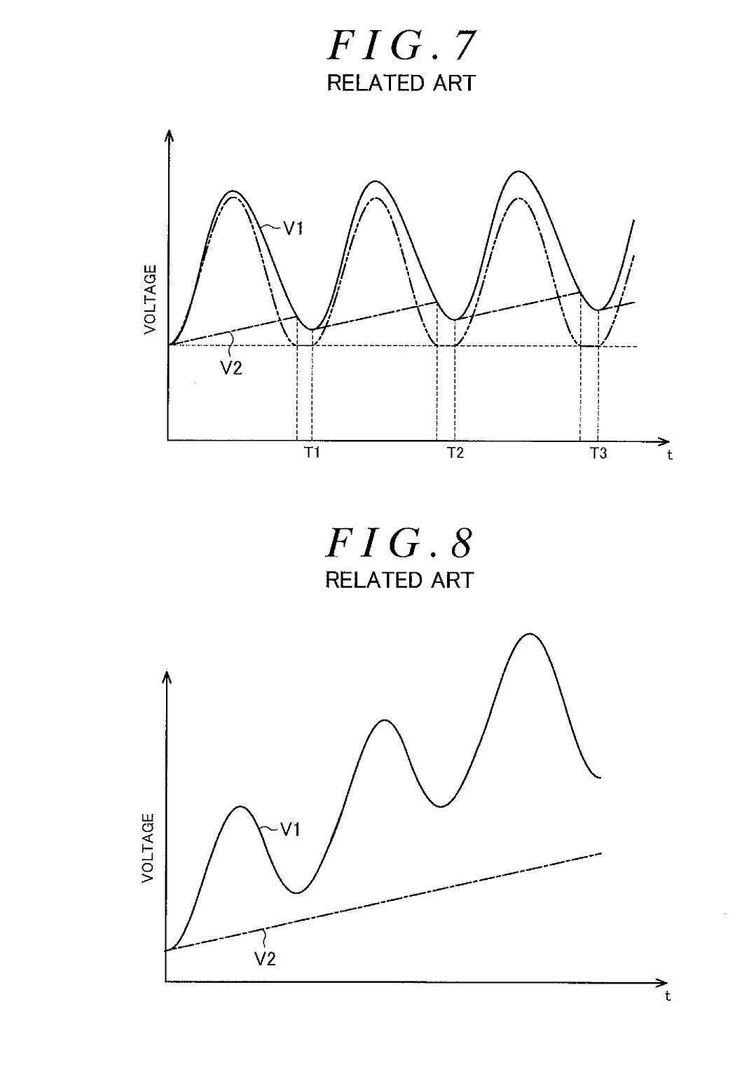

The workings and effects of the cylinder internal pressure sensor 30 of this embodiment will be described with reference to FIG. 4 to FIG. 6. As shown in FIG. 4, in a cylinder internal pressure sensor of the related art, the influence of pressure and temperature is reflected in the end-to-end voltage of the sensor element, so that a bottom voltage Vb of the end-to-end voltage changes according to the amount of heat received in each combustion cycle. In this embodiment, the ceramic heater 70 and the control unit 92 maintain the temperature of the sensor element 60 at a temperature higher than the highest temperature reached by the sensor element 60 when subjected to the heat of combustion. Thus, even when subjected to the heat of combustion, the sensor element 60 undergoes little temperature change. Accordingly, as shown in FIG. 5, it is less likely that the influence of temperature changes of the sensor element 60 due to the heat of combustion is reflected in an end-to-end voltage Vc of the sensor element 60, and a bottom voltage Vd of the end-to-end voltage Vc undergoes little change in each combustion cycle. It is therefore possible to make it more likely that the end-to-end voltage Vc of the sensor element 60 reflects only the influence of the cylinder internal pressure. Thus, the influence of the temperature on the end-to-end voltage Vc of the sensor element 60 can be removed more properly regardless of the degree of changes in the heat of combustion.

The control unit 92 controls the temperature of the sensor element 60 to the predetermined temperature that is higher than the highest temperature reached by the sensor element 60 when subjected to the heat of combustion, and the temperature of the sensor element 60 is maintained at the predetermined temperature. Accordingly, unlike in the configuration in which the amount of heat generated by the ceramic heater 70 is varied such that the difference between the actual temperature of the sensor element 60 and the temperature of the sensor element 60 when subjected to only the heat of combustion remains constant, complication of controlling the ceramic heater 70 is avoided, and therefore the behavior of the ceramic heater 70 is stabilized.

The ceramic heater 70 is fixed at one end face to the sensor element 60 and at the other end face to the thermal insulation member 80, and the thermal insulation member 80 prevents the heat of the ceramic heater 70 from escaping through the other end face. Thus, heat is transferred intensively from the ceramic heater 70 to the sensor element 60. In other words, the heat of the ceramic heater 70 is less likely to be transferred to other portions while the heat is more likely to be transferred to the sensor element 60, so that the ceramic heater 70 can heat the sensor element 60 with higher efficiency.

The ceramic heater 70 and the sensor element 60 are fixed to each other through the adhesive layer 75 that is made of an adhesive containing carbon. Since carbon has high thermal conductivity, the thermal conductivity of the adhesive layer 75 made of an adhesive containing carbon is also high. Thus, even when the sensor element 60 and the ceramic heater 70 are fixed to each other through the adhesive layer 75, a large amount of heat can be transferred from the ceramic heater 70 to the sensor element 60. Moreover, since the entire upper end face of the ceramic heater 70 and the entire lower end face of the sensor element 60 are fixed through the adhesive layer 75, it is possible to prevent uneven heating of the sensor element 60 and even out the temperature in the sensor element 60.

In this embodiment, the influence of the temperature is eliminated and changes in bottom voltage Vd of the end-to-end voltage Vc of the sensor element 60 are suppressed. Accordingly, as shown in FIG. 6, the detection unit 93 of the circuit part 90 can amplify the end-to-end voltage Vc so as to raise the peak voltages due to changes in the cylinder internal pressure while lowering the overall level of the bottom voltage Vd. Thus, the dynamic range is widened and quantization noise in analog-digital conversion in the detection unit 93 is reduced, so that the cylinder internal pressure can be accurately detected.

The above embodiment can also be implemented with the following changes made thereto. The adhesive composing the adhesive layer 75 is not limited to an adhesive containing carbon. For example, the adhesive layer 75 may be made of an adhesive that contains, instead of carbon, a metal filler or ceramic particles having high thermal conductivity (e.g., aluminum nitride or alumina). Alternatively, the adhesive layer 75 may be made of an adhesive that contains none of carbon, a metal filler, and the ceramic particles.

The ceramic heater 70 and the sensor element 60 may be directly fixed to each other without the adhesive layer 75 interposed between the ceramic heater 70 and the sensor element 60. Alternatively, the ceramic heater 70 and the sensor element 60 may be fixed to each other through a component other than the adhesive layer 75. In this case, it is desirable that the component be made of a material having high thermal conductivity.

The adhesive layer 75 is formed by applying the adhesive to the entire upper end face of the ceramic heater 70 in the above embodiment, but the adhesive layer 75 may instead be formed by applying the adhesive to only a part of the upper end face. Alternatively, the adhesive layer 75 may be formed by applying the adhesive to a plurality of regions of the upper end face. Moreover, the adhesive layer 75 may be formed by applying the adhesive to the lower end face of the sensor element 60.

The thermal insulation member 80 may be made of ceramic other than zirconia, for example, of alumina. Alternatively, the thermal insulation member 80 may be made of a material other than ceramic.

The thermal insulation member 80 is not absolutely required. For example, the thermal insulation member 80 can be omitted in the case of a configuration in which the ceramic heater 70 is directly fixed to the insert part 51 of the opposed member 50. The aspect of the setting of the predetermined temperature can be changed as appropriate. For example, a temperature that is more than 10° C. different from the highest temperature reached by the sensor element 60 when subjected to the heat of combustion during steady operation of the internal combustion engine may be set as the predetermined temperature. Alternatively, a temperature that is higher than the highest temperature reached by the sensor element 60 when subjected to the heat of combustion during steady operation of the internal combustion engine and that is less than 10° C. different from that temperature may be set as the predetermined temperature.

In the above embodiment, the control unit 92 sets the predetermined temperature on the basis of the temperature stored in advance. However, a temperature higher than the highest temperature reached by the sensor element 60 when subjected to the heat of combustion during steady operation of the internal combustion engine may be stored in advance as the predetermined temperature in the control unit 92.

The temperature stored in the control unit 92 is not limited to the highest temperature reached by the sensor element 60 when subjected to the heat of combustion during steady operation of the internal combustion engine. For example, the highest temperature reached by the sensor element 60 when subjected to the heat of combustion in the entire operation range of the internal combustion engine 10 including operation with abnormal combustion, such as knocking and pre-ignition, may be stored.

In the above embodiment, the control of the current applied to the ceramic heater 70 may be performed prior to an engine start. Specifically, an action that is made before an engine start, such as unlocking of a door of the vehicle or opening of a door, may be used as a trigger to start the application of a current to the ceramic heater 70. According to this configuration, the temperature of the sensor element 60 can be quickly raised at an engine start.

In the above embodiment, the temperature of the sensor element 60 is controlled to the predetermined temperature through intermittent application of a current to the ceramic heater 70. However, the control method for maintaining the temperature of the sensor element 60 at the predetermined temperature can be changed as appropriate. For example, the temperature of the sensor element 60 may be maintained at the predetermined temperature through continuous application of a smaller amount of current to the ceramic heater 70.

A constant value is used as the predetermined temperature in the above embodiment, but a configuration in which the predetermined temperature is set to vary according to the operation state of the engine may instead be adopted. For example, a map showing a relation between the heat of combustion inside the combustion chamber 15 and the temperature of the sensor element 60 when subjected to the heat of combustion is stored in advance in the control unit 92. During engine operation, the heat of combustion to be generated in the next combustion cycle is estimated at each time from various parameters, such as the engine speed, the engine load, the fuel injection amount, and the intake air temperature. Then, on the basis of the estimated heat of combustion and the map, the temperature of the sensor element 60 when subjected to the heat of combustion in the next combustion cycle is estimated. The estimated temperature of the sensor element 60 is one example of the first predetermined temperature. The control unit 92 sets a temperature that is, for example, about 10° C. higher than the estimated temperature of the sensor element 60 as the predetermined temperature, and controls the amount of current applied to the ceramic heater 70 to thereby control the temperature of the sensor element 60 to the predetermined temperature. Setting the predetermined temperature so as to vary among combustion cycles as in this configuration can also maintain the temperature of the sensor element 60 in each combustion cycle at a temperature higher than the temperature reached by the sensor element 60 when subjected to the heat of combustion in each combustion cycle. It is therefore possible to make it less likely that the influence of temperature changes due to the heat of combustion is reflected in the end-to-end voltage of the sensor element 60, and to make it more likely that the end-to-end voltage of the sensor element 60 reflects only the influence of the cylinder internal pressure. As a result, the influence of the temperature on the end-to-end voltage of the sensor element 60 can be removed regardless of the degree of changes in the heat of combustion. Moreover, in such a configuration, only a minimum amount of current according to the heat of combustion at each time is required to be applied to the ceramic heater 70, which can contribute to enhancing the fuel efficiency.

While the example where the ceramic heater 70 is employed as the heating element has been shown, another component may be employed as the heating element. For example, instead of the ceramic heater 70, a Peltier element may be employed as the heating element.

As long as the temperature of the sensor element 60 can be detected, the temperature sensor 37 may be omitted. For example, the temperature sensor 37 is not required in the case where the temperature of the sensor element 60 is detected on the basis of the resistance value of the sensor element 60 when the combustion pressure is not acting thereon.

The method by which the control unit 92 controls the amount of heat generated by the heating element is not limited to feedback control, but feedforward control may be used instead. The sensor element 60 is not limited to that of the above embodiment, but a piezoelectric element that generates electric charges in varying magnitude according to pressure and temperature may be used instead.

What is claimed is:

1. A cylinder internal pressure sensor to be disposed inside a combustion chamber of an internal combustion engine, the cylinder internal pressure sensor being configured to be subjected to heat of combustion inside the combustion chamber and a pressure inside the combustion chamber, the cylinder internal pressure sensor comprising:
a housing;
a diaphragm joined to one end of the housing, the diaphragm being configured to deflect according to the pressure inside the combustion chamber;
a sensor element housed inside the housing, the sensor element being coupled to the diaphragm, and the sensor element being configured to change a signal to be output according to a temperature inside the combustion chamber and the pressure inside the combustion chamber;
a heating element configured to heat the sensor element; and
a control unit configured to control an amount of heat generated by the heating element such that the temperature of the sensor element becomes higher than a first predetermined temperature that is the temperature of the sensor element when subjected to the heat of combustion.

2. The cylinder internal pressure sensor according to claim 1, wherein the control unit is configured to control the amount of heat generated by the heating element such that the temperature of the sensor element becomes higher than a second predetermined temperature that is a highest temperature reached by the sensor element when subjected to the heat of combustion.

3. The cylinder internal pressure sensor according to claim 1, further comprising a thermal insulation member housed inside the housing, wherein the heating element is fixed at one end face to the sensor element and at another end face to the thermal insulation member.

4. The cylinder internal pressure sensor according to claim 1, further comprising an adhesive layer provided between the heating element and the sensor element, the adhesive layer containing carbon and an adhesive, wherein the heating element and the sensor element are fixed to each other through the adhesive layer.
